(19) United States
(12) Patent Application Publication
(10) Pub. No.: US 2012/0023065 A1
(43) Pub. Date: Jan. 26, 2012

(54) SYSTEM AND METHOD FOR MANAGING DATA ON AN OCCASIONALLY CONNECTED MOBILE DEVICE

(76) Inventors: William DeWeese, Haltom City, TX (US); Caroline Marlow, Fort Worth, TX (US)

(21) Appl. No.: 12/839,492

(22) Filed: Jul. 20, 2010

(51) Int. Cl. G06F 17/30

(52) U.S. Cl. 707/613; 707/802; 707/E17.005

(57) ABSTRACT

A system for synchronizing data on an occasionally connected mobile device includes a mobile device with a computer memory storing a plurality of files, an application that causes a change in at least one of the plurality of files, a change detection module configured to detect the change, a message creation module configured to create and queue a message with information regarding the change, a network detection module configured to detect a network connection, and a transmitting module configured to transmit the message when the network connection is detected. A cloud database and a server that receive information regarding the change at the mobile device and also transmit to the mobile device information regarding changes at the server are also described. Methods of synchronizing files across the mobile device, the cloud database, and the server are also described.

### FIELD OF THE INVENTION

Described embodiments relate generally to the field of mobile device communications, and more particularly, to a system and method for managing files on a mobile device that is intermittently connected to a data source via a wireless connection.

### BACKGROUND OF THE INVENTION

Mobile electronic devices, such as cellular telephones, smartphones, and other mobile Internet devices, have become useful tools for communicating, storing information, and running software applications. Smartphones, in particular, have come to offer advanced computing ability and connectivity. Smartphones incorporate the functions of a computer with a mobile cellular telephone, and can provide multiple ways to connect to the Internet.

Accordingly, mobile electronic devices are being increasingly used for important workplace data storage and manipulation. These devices are being used by employees in the field to capture, store, manipulate, and update data. For example, employees responsible for maintenance of everything from military aircraft to digital copiers must often be located away from central data repositories, yet still require access to customer and technical data. In addition to access, is also desirable for employees to be able to update data in the central data repositories from their mobile devices.

A problem arises, however, in synchronizing data between the mobile device and remote storage. Mobile devices may be used at any hour of any day, and it is important that data be updated on a remote storage in a timely manner. Additionally, mobile devices often do not maintain a constant data connection, which can prevent transmission of data at given times. Mobile devices also have limited processing power, so it is desirable to have a system that can universally monitor and update data used by multiple applications, without requiring that each application handle its own updating of the remote storage. Additionally, when handling information in sensitive fields such as those involving government contracts, it is desirable that data access be limited and secure. Accordingly, there is a need in the art for a solution for managing files on a mobile device that accounts for these inherent limitations of the mobile device.

### BRIEF SUMMARY OF THE INVENTION

The described embodiments overcome the above deficiencies by providing a system and method for updating data on an occasionally connected mobile wireless device. An exemplary embodiment includes a server comprising a server database and a module configured to receive a message that includes information related to a change in a file structure on a cloud database. The cloud database of the embodiment includes a cloud file structure, a change detection module configured to detect a change in the cloud file structure, and modules for transmitting and receiving messages to and from the server and a mobile device. The mobile device includes a mobile device file structure, a change detection module configured to detect a change in a file made by an application, and a module for transmitting and receiving messages to and from the cloud database without requiring that the application be running on the device at the time of the transmission. The file structure of the server database, the cloud file structure, and the mobile device file structure may include the same directory structure.

Another exemplary embodiment includes storing files in memory of a mobile device, changing a property of at least one file using an application of the mobile device, detecting a change in the property of the file on the mobile device, queuing a message with information regarding the change, detecting a wireless data connection and transmitting, via the wireless data connection, the message with the information regarding the change. The embodiment may further include receiving the files at a cloud database in a second location, modifying files in the cloud database, and transmitting the file to a server in a third location, where a file on a server database is updated. The embodiment does not require that the application that changes the property of the at least one file be running when the message with the information regarding the change is transmitted. Additionally, the files structure of the mobile device, the cloud database, and the server may include the same directory structure.

Another exemplary embodiment includes a non-transitory computer readable medium storing a program for updating files on a mobile device, the program comprising a detection module configured to detect a change in at least a file of a plurality of files on the mobile device, a message creation module configured to queue a message with information regarding the change, a wireless detection module configured to detect a wireless data connection, a transmission module configured to transmit, via the wireless data connection, the message with the information regarding the change when the wireless data connection is detected. The background module may be configured to detect the change and the transmission module may be configured to transmit the message even when an application that changes the file is not running on the device. The plurality of files on the mobile device may be organized with a directory structure that is the same as a directory structure on a server and/or a cloud database.

Another exemplary embodiment includes a mobile device comprising a computer memory storing a plurality of files, an application that causes a change in at least one of the plurality of files, a change detection module configured to detect the change in the at least one of the plurality files, a message creation module configured to create and queue a message notifying of the change, a network detection module configured to detect a network connection; and a transmitting module configured to transmit the message after the network connection is detected. The change detection module, message creation module, and transmitting module may be configured to detect the change, create and queue the message, detect the network connection, and transmit the message when the application is not running on the mobile device. The plurality of files in the computer memory of the mobile device may be organized with a directory structure that is the same as a directory structure on a server and/or a cloud database.

### BRIEF DESCRIPTION OF THE DRAWINGS

FIG. 1 is a schematic diagram showing the interaction of components in the data update system constructed in accordance with an embodiment described herein;

FIG. 2 is a schematic diagram showing the interaction and structure of components in the data update system constructed in accordance with another embodiment described herein;

FIG. 3 is a schematic diagram showing the interaction and structure of components in the data update system constructed in accordance with another embodiment described herein;

FIG. 4 is a flow chart demonstrating a procedure for detecting a change on a device and providing a message with information describing the change in accordance with an embodiment described herein;

FIG. 5 is a flow chart demonstrating a procedure for transmitting a queued message when a data connection is detected in accordance with an embodiment described herein;

FIG. 6 is a flow chart demonstrating a procedure for updating a file on a mobile device in accordance with an embodiment described herein.

### DETAILED DESCRIPTION OF THE INVENTION

Embodiments described herein relate to a method and system of managing data on a mobile device that has an intermittent connection to the Internet. Embodiments include a main server with a server database, a cloud database, and a wireless mobile device. These components enable the maintenance and synchronization of files on all three systems. Embodiments also include a mobile device with an application that monitors changes to a file structure that is modified by other applications, and queues messages with information regarding the changes for transmission when the mobile device receives an Internet connection.

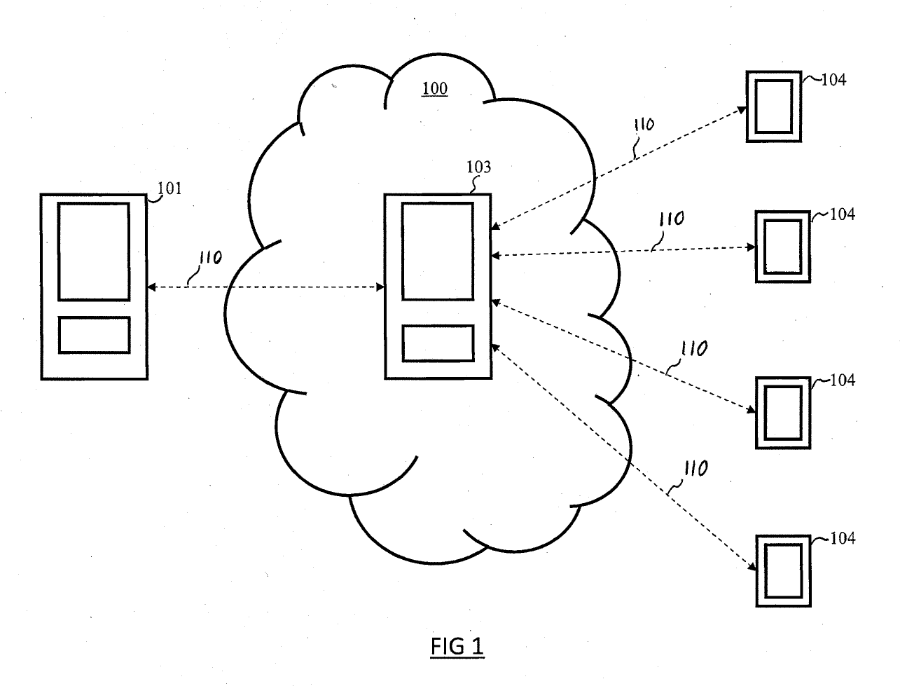

FIG. 1 is a schematic diagram showing an overview of the interaction and structure of system components constructed in accordance with an embodiment described herein. A server 101 stores files that are relevant to operations on a mobile device 104, and may be copies of files that will be accessed and modified on the mobile devices 104. The server 101 can be located at central place of business, such as an office or headquarters of a company and may store many types of information other than the files that are relevant to operations on the mobile device 104.

The server 101 is connected to a cloud database 103 via an Internet connection 110. The cloud database 103 can be located anywhere that is connected to the Internet 100 and is capable of communicating with the server 101. The cloud database 103 contains data storage and can replicate part or all of the information on the server 101. To conserve resources, the cloud database 103 may only replicate necessary files from the server 101, and may be limited to storing only the files that are to be transferred between the server 101 and the mobile devices 104.

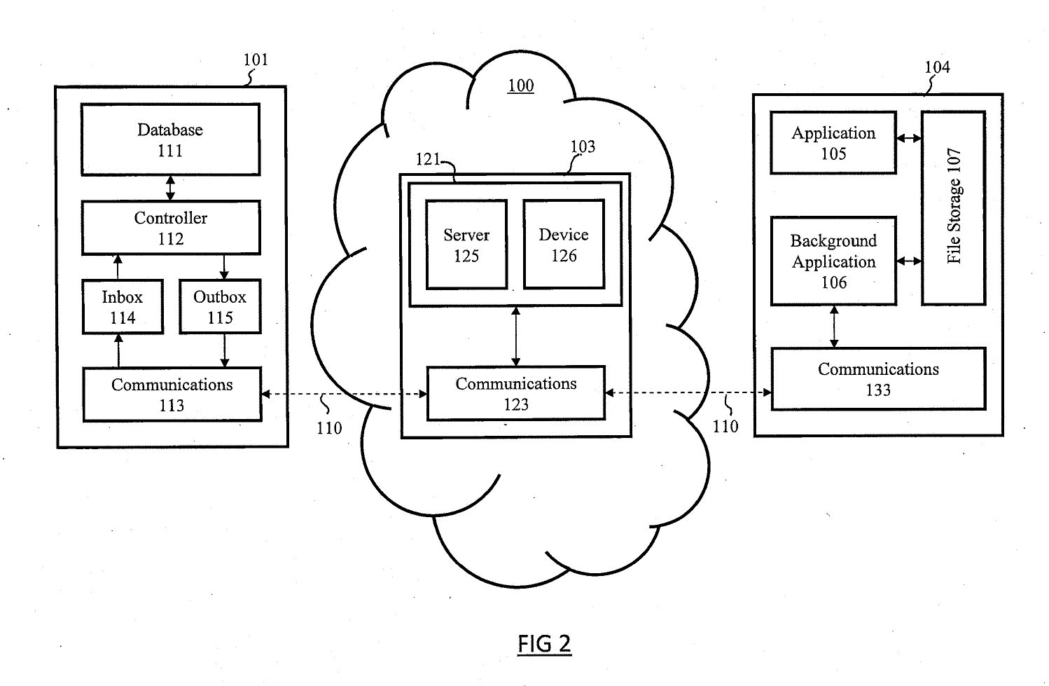

The server 101 and the cloud database 103 may have different hours of operation. For example, the server 101 may have a one hundred percent or near one hundred percent uptime, while the database 111 (shown in FIG. 2) of the server 101 may only be operational during business hours, or may have routine downtime for maintenance. The cloud database 103 may therefore function as what is commonly referred to as “cloud storage,” providing data from a remote location that can be accessed from multiple other locations at any time. In this manner, the cloud database 103 may be at a different location serviced by a third party providing similar services to multiple companies, and may therefore be highly scalable.

The remote database communicates, via an Internet connection 110, to a plurality of mobile devices 104. The mobile devices 104 contain files that can be accessed or modified, and information regarding modification to the files is transmitted to the cloud database 103 via the Internet connection 110 when the Internet connection 110 is available. After the messages are received at the cloud database 103, the cloud database 103 transmits the information regarding the modification to the server 101 when the Internet connection 110 to the server 101 is available. Similarly, information regarding changes at the server 101 can be transmitted to the cloud database 103 and then from the cloud database 103 to the mobile devices 104.

Transmission of files may be accomplished by storing, on the cloud database 103, a folder in the file structure that is assigned to each individual mobile device. Within that folder, a first subfolder is created for information received from the mobile device 104 destined for the server 101 and second subfolder is created for information sent from the server 101 destined for the mobile device 104. The mobile device 104 periodically transmits any information destined for the server 101 to the first subfolder, and receives information from the second subfolder. Similarly, the server 101 periodically transmits any information destined for the mobile device 104 to the second subfolder, and receives information from the first subfolder.

FIG. 2 is a schematic diagram showing the interaction and structure of components in the data update system constructed in accordance with the embodiment described herein. As illustrated in FIG. 2, server 101 contains a server database 111, a controller 112 for monitoring and modifying files on the server database 111, data storage containing an inbox 114 and outbox 115 for information that should be sent to, or has been received from, a mobile device 104, and a communications module 116 that communicates with a cloud database 103 via an Internet connection.

The server database 111 can be a single computer or multiple computers forming a distributed database storing and/or replicating information across the multiple computers. The server database 111 contains data that includes at least copies of the files that will be manipulated on a mobile device 104, but may also contain other, unrelated files for other functions of the server 101. The controller service 112 is used to monitor and update the database 111. The controller service 112 can modify files of the database 111 based on incoming communications placed in the server inbox 114 by the communications module 116. The controller service 112 can also detect changes in the data 111 and, where appropriate, place messages with information regarding those changes in an outbox folder 115.

The server communications module 116 monitors the outbox folder 115 and, when it detects a message in the outbox folder 115, transmits the message over the Internet 100 via an Internet connection 110. When the server communications module 116 receives a transmission from the cloud database 103, the information is placed in the inbox 114.

The server communications module 116 communicates with a cloud database 103 over the Internet 100 via an Internet connection 110. The cloud database 103 may be a single computer or multiple computers forming a distributed database storing and/or replicating information across multiple computers, and may be located in a geographically remote location from the server 101.

The cloud database 103 contains data including copies of at least some of the files of the server database 111. For example, the cloud database 103 includes a user data folder 121 that corresponds to each user of a mobile device, and the user data folder 121 includes a server folder 125 and a device folder 126. A cloud communications module 123 places messages received from the server 101 and intended to update the mobile device 104 in the device folder 126. The cloud communications module 123 places messages received from the mobile device 104 and intended to update the server 101 in the server folder 125.

When a connection between the server 101 and the cloud communications module 123 is established, the server 101 transmits all information in the outbox 115 to the cloud communications module 123, and the cloud communications module 123 transmits all data in the server folder 125 to the server 101.

The server folder 125 on the cloud database 103 and the inbox 114 and outbox 115 of the server 101 may, for simplicity of implementation and operation, have a similar or identical file structure. That is, each storage unit may contain a folder designating a particular mobile device 104, and then a file structure for files within that mobile device. Accordingly, changes can be copied over from the server 101 to the cloud database 103, replacing the files on the existing cloud database 103 folder, and vice versa.

The communications module 123 of the cloud database 103 also transmits information to and from the mobile device 104 over the Internet 100 via an Internet connection 110. The mobile device includes a file storage 107, at least one application 105 that manipulates data in the file storage, a continuously running background application 106 that detects changes in certain files of the file storage 107 and creates and queues messages containing information related to the changes, and a communications module 133 that detects an available wireless data connection and transmits the messages when the connection is available. Since a message can be queued by the background application 106 and transmitted by the communications module 133, both of which can be executed separately from the application 105, it is not necessary for the application 106 to be running to transmit the change.

The mobile device 104 may be any electronic wireless device that receives, stores, and transmits information over a data connection. The mobile device 104 may be, for example, a cellular telephone such as the Apple iPhone (running the iOS operating system), the Motorola Droid (running the Google Android operation system), or a BlackBerry device (running the BlackBerry OS). The mobile device transmits information over the Internet using a cellular connection, such as a 3G, 4G, EVDO, or CDMA connection, or using any other wireless transmission method, such as a wireless local area network using the IEEE 802.11 standard that is connected to the Internet.

The file storage 107 of the mobile device 104 stores files used by the mobile device. The file storage 107 includes files that are used and modified by at least one application 105. The application 105 may be any application, such as a word processing application or a proprietary application developed for a specific business purpose. For example, the application 105 may be designed to allow an employee to enter timesheets, which can be sent to the server 101 for processing, and returned as confirmation copies to the mobile device. The application 105 may also be used for a mobile device user to fill out survey information and have the information sent to the server 101 or take training quizzes and have the answers sent to the server 101. In these implementations, the sever 101 can perform processing on the received information and return additional information, such as a confirmation for a survey or a quiz score for training quizzes.

The mobile device 104 also includes a second application that is a background application 106. While the application 105 may be executed only when a user selects the application, the background application 106 can run at all times the device is in operation. The background application 106 monitors the file storage 107 for any changes in the files or some sub-set of files that have been selected for monitoring. When a change detection module of the background application 106 detects a change in one of the files of the file storage 107 that have been selected for monitoring, a message creation module of the background application 106 queues a message containing information regarding the change in the file, and provides the message to a transmission module 133.

The transmission module 133 of the mobile device is configured to queue messages, and to detect whether there is a wireless data connection at the mobile device 104. If there is no connection, the messages remain queued. Once there is a wireless data connection, the messages are transmitted to the cloud database 103, where the cloud communications module 123 places the message in the server folder 125. Then, the next time there is a connection between the server 101 and the cloud database 103, the message in the server folder 125 is transmitted via the Internet connection 110 to the server 101. The server communications service 116 places the message in the inbox 114, and the controller 112 updates the database 111 according to the information in the message. Thus, the changes made on the mobile device 104 are transmitted via the cloud database 103 to the server 101 when the mobile device 104 receives a data connection after the change. The transmission of these changes do not require that the application 105 be running at the time of the transmission.

The mobile device 104 thus synchronizes files in a file storage 107 whenever an Internet connection 110 is available. When no connection is available, messages containing information regarding changes to files are queued by the background application 106 and the communications module 133. Though the background application 106 and communications module 133 are illustrated in FIG. 2 as separate components, they can be an integrated application that interfaces with a hardware data transmission device. The application 105, the background application 106, and the communications module 133 can be implemented as instructions stored on a non-transitory computer readable storage.

The background application 106 can detect changes in files that are accessed and modified by multiple applications 105. Accordingly, the ability to synchronize changes with a server database 101 does not need to be integrated with or handled by each individual application 105, but can instead be handled universally by the background application 106 monitoring the file storage 107.

Changes made to data in the database 111 at the server 101 can also be transmitted to the mobile device 104. When a change to data in the database 111 is detected by the controller 112 of server 101, a message with information regarding the change is placed in the outbox 115. The server communications module 116 detects the message in the outbox 115, and transmits a message with information regarding the change to the communications module 123 of the cloud database 103. At the cloud database 103, the message is placed in the device folder 126 of the user data folder 121 that corresponds to the affected device. The correct user data folder 121 may be selected based on information in the message, metadata information, or information in a file contained in the message. Then, when the communications module 123 is next connected to the mobile device 104, the message is transmitted from the cloud database 103 to the mobile device 104. When the mobile communications module 133 of the mobile device 104 receives the message, the background application 106 updates the file storage 107 based on the information contained in the message. If multiple messages are received at the server 101 or at the mobile device 104, they are processed based on a timestamp identifying the time that the file was initially changed on the server 101 or the mobile device. 104.

Optionally, the background application 106 may present a message to a user notifying of the update, or may provide a notification to the Application 105 notifying of a change when a change is received from the server 101. Also optionally, the messages may be sent using a secure protocol. For example, transmissions between the server 101 and the cloud database 103 may be made via secure file transport protocol (SFTP), and the transmissions between the cloud and the device may be made via hypertext transfer protocol secure (HTTPS).

The messages transmitted via the system may be the files that are modified by the mobile device 104 or the server 101. The messages may also be XML files that contain data collected from the server 101 or the mobile device 104, such as timesheet data, survey answers, or quiz answers. In other implementations, the messages are text messages, video file recordings, or word processing documents that contain information collected at the server 101 or mobile device 104.

In addition to the exchange of changes to files, the system may be configured to perform distributed processing of data. In other words, the server 101 may be configured to receive data from the mobile device 104, perform processing on data received and return the results of the processing to the outbox 115. In this manner, data received from the mobile device 104 is processed, and then returned to the mobile device 104. For example, a user can submit timesheet data via the mobile device 104, and the timesheet data can be transmitted, via the cloud database 103, to the server 101. The server can process the timesheet and transmit a error or success message back to the device so that the user can fix any items necessary.

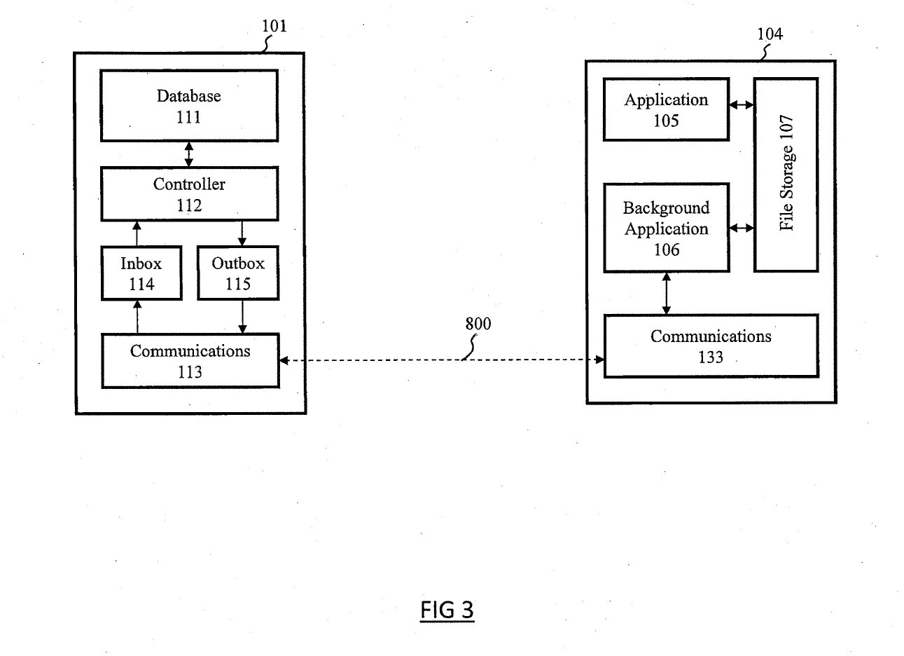

FIG. 3 illustrates another embodiment that does not include the cloud database 103. This embodiment is similar to the embodiment of FIG. 3 embodiment except that, in this embodiment, the mobile device 104 transmits information directly to the server 101. As illustrated in FIG. 3, the system includes a server 101 and a mobile device 104 with the same components as the server 101 and mobile device 104 in FIG. 2. Here, however, unlike in FIG. 2, the server communications module 113 transmits a message including information about changes to the server database 111 from the outbox 115 to the mobile device 104. The information is transmitted over a data connection 800. Similarly, messages from the mobile communications module 133 of the mobile device 104 are transmitted server communications module 133 via data connection 800. The data connection 800 may be any connection capable of transmitting the information, such as an Internet connection, a local area network, a Bluetooth connection, or a USB connection.

At the server 101, the server communications module 116 places the incoming messages in the inbox 114. This embodiment has an advantage of being simpler and potentially less expensive to implement, but it does not have the advantages of the cloud database, which can improve uptime and provide redundancy and scalability. Additionally, this embodiment need not necessarily reply on an Internet connection to collect data, as the information could be transmitted directly to the server 101 via a local area network, a Bluetooth connection, or other data link.

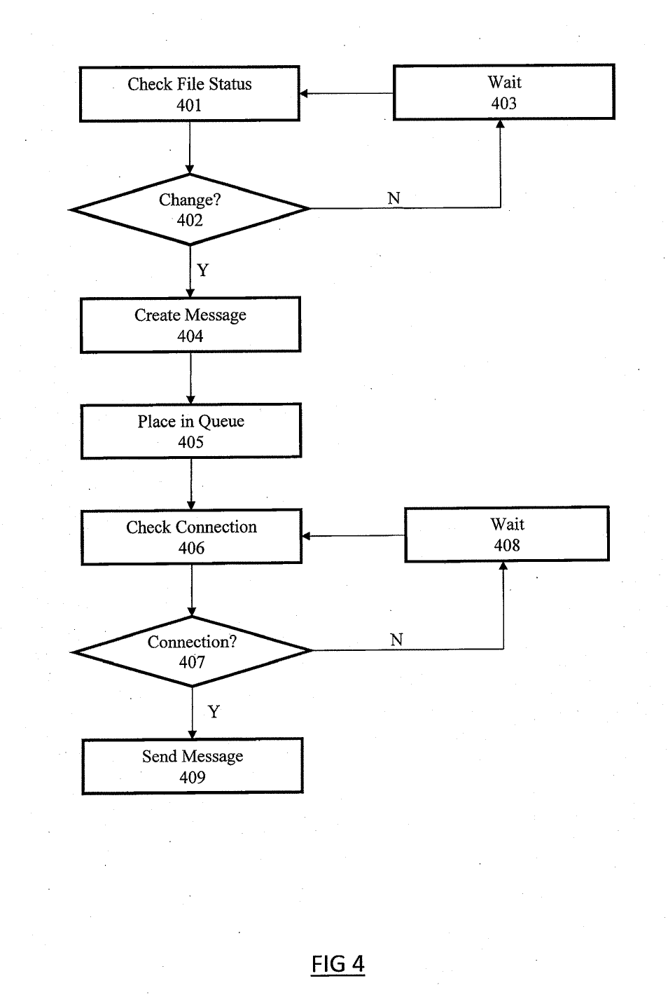

FIG. 4 illustrates a procedure for detecting a change on a mobile device and providing a message with information describing the change. The FIG. 4 procedure may be used in a system such as those described in FIGS. 1-3, and may incorporate additional features of those systems that are not specifically illustrated in FIG. 4. First, at step 401, the background application 106 of the mobile device 104 checks the file status of the files or the file folder that has been designated for monitoring. If no change is detected at step 402, the background application 106 is configured to wait for a certain period of time, number of processor clock cycles, or a detected change in physical location of the mobile device at step 403 until performing another check of the file status. The application may be configured to detect a change in physical location via a cellular telephone connection, via detection of a local wireless network, or via a GPS module.

If a change is detected at step 402, the procedure proceeds to step 404. At step 404, a new message is created. The message includes information regarding the change in the file status of the files or the file folder that is being monitored. The message may be an XML file including information on the change and may comprise the file that has been changed. At step 405, the message is placed in a queue. The queue may include other messages regarding changes in file status, or may include other, unrelated, messages queued for sending from the mobile device 104.

At step 406, when messages have been placed in a queue, a wireless detection module of the mobile device checks to determine if there is an available wireless data connection from the mobile device. If a data connection is unavailable at step 407, the procedure waits a certain period of time, number of processor clock cycles, or a detected change in physical location of the mobile device at step 408 before returning to step 406 to again check for an available wireless data connection. If a wireless data connection is detected at step 407, the message is transmitted at step 409.

Though FIG. 4 illustrates the procedure as including certain wait cycles at steps 401-403 and steps 406-408, these portions of the procedure could also be implemented as active procedures, where instead of repeated checks the procedure operates by receiving a notification of the status changes and proceeds to the next step only when that notification is received.

The FIG. 4 message may be transmitted to a communications module 123 of a cloud database 103 (as in FIG. 2), or to a server 101 (as in FIG. 3). The file structure of the cloud database 103 and/or the server 101 can be the same as the file structure on the mobile device 104, so that the files are similarly organized and can be easily synchronized across devices.

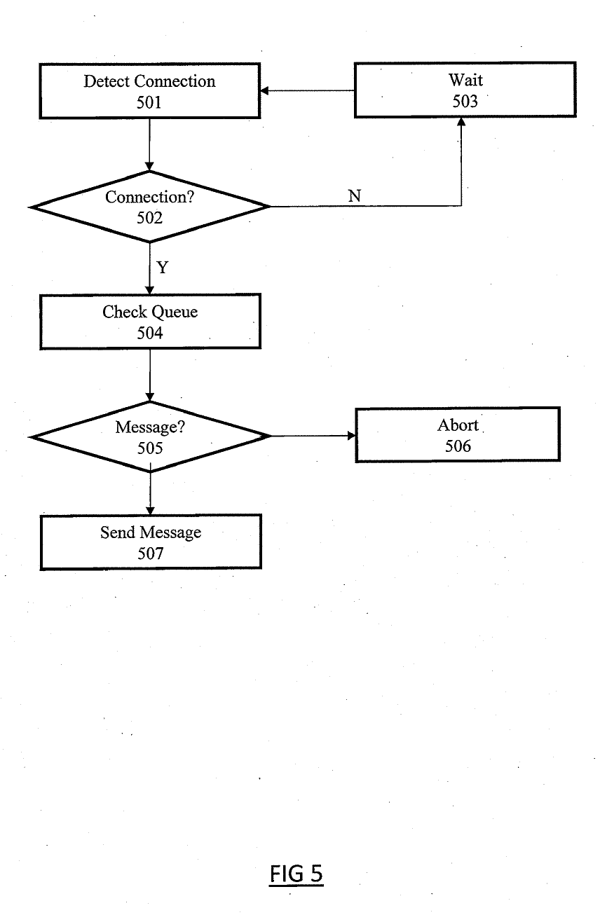

Both the mobile device 104 and the database 103 can use the same procedure for transmitting updates when a data connection is detected. FIG. 5 illustrates a procedure for transmitting a queued message when a data connection is detected on a device or a database. The FIG. 5 procedure may be used in a system such as those described in FIGS. 1-3, and may incorporate additional features of those systems that are not specifically illustrated in FIG. 5. At step 501, a communications module of the device or database checks to see if there is an available wireless data connection. If no connection is detected at step 502, the device or database proceeds to step 503, which waits a predetermined period of time, number of processor clock cycles, or for a change in location of the mobile device. If, at step 502, a wireless data connection is available, the communications module checks the queue on the mobile device or the database to determine if there is a message to be sent at step 504. If no message is detected at step 505, the procedure aborts at step 506. If a message is detected in the queue, the message is sent at step 507. Similar to FIG. 4, the wait cycle at steps 502-504 could instead be implemented by proceeding only after receiving a notification of a change.

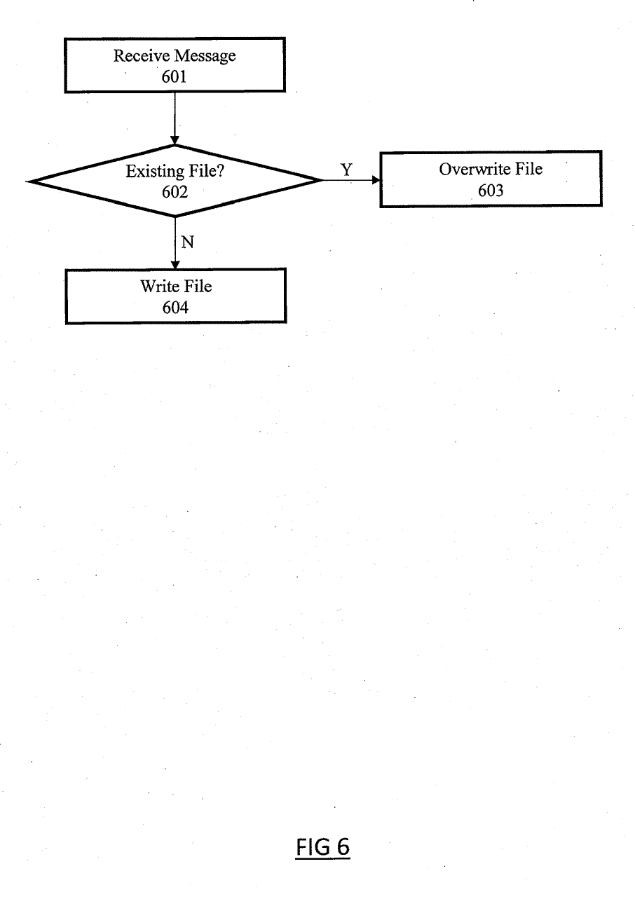

FIG. 6 illustrates a procedure for updating a file on a mobile device when a message with information about a change on the server is received at the mobile device. The FIG. 6 procedure may be used in a system such as those described in FIGS. 1-3, and may incorporate additional features of those systems that are not specifically illustrated in FIG. 6. At step 601, a message is received at the mobile device by, for example, the communications module. At step 602, the mobile device checks to see if the file exists. By way of example, this may be accomplished via the background application 106 (illustrated in FIG. 2). If the file exists, it is overwritten with the information received at the mobile device at step 603. If the file does not exist, it is written to the device as a new file at step 604.

The processes and devices in the above description and drawings demonstrate examples of methods and devices of many that could be used and produced to achieve the objects, features, and advantages of embodiments described herein. While the invention has been described in detail and with reference to specific embodiments thereof, it would be apparent to those skilled in the art that various changes, arrangements and modifications may be applied therein without departing from the spirit and scope of the invention. Thus, the embodiments are not to be seen as limited by the foregoing description of the embodiments, but only limited by the appended claims.

What is claimed as new and desired to be protected by Letters Patent of the United States is:

1. A method of updating files on a mobile device, comprising:
storing a plurality of files on a memory of the mobile device;
changing a property of at least a file of the plurality of files using a first application;
detecting the change in the property of the file on the mobile device using a second application that is different than the first application;
queuing a message with information regarding the change;
detecting a wireless data connection;
transmitting, via the wireless data connection, the message with the information regarding the change.

2. The method of claim 1, further comprising
receiving, at a database located in a second location that is different than a first location that is a location of the mobile device, the information regarding the change; and
modifying files at the database based on the information regarding the change.

3. The method of claim 2, further comprising
detecting a change in the files at the database located in the second location; and
transmitting, from the second location to a third location that is different than the location of the mobile device and the second locations, a message with information regarding the change in the files at the database.

4. The method of claim 3, further comprising:
receiving, at the third location, the message with information regarding the changes in the database; and
updating a server database at the third location based on the information regarding the changes in the database.

5. The method of claim 1, further comprising
detecting, at a third location, a change in a file in a server database at the third location;
transmitting, from the third location to a second location, a message with information regarding the change in the file in the server database;
changing, at the second location, at least one file based on the message with information regarding the change in the file in the server database transmitted from the third location;
transmitting, from the second location to the mobile device, a message that includes information regarding the changing, at the second location, the at least one file; and
changing at least one file on the mobile device based on the message that includes information regarding the changing, at the second location, the at least one file.

6. The method of claim 1, wherein the mobile device is a cellular telephone.

7. The method of claim 1, wherein the mobile device is a device connected to a wireless local area network

8. The method of claim 1, wherein the message with information regarding the change is an XML file.

9. The method of claim 1, wherein the queuing occurs when the device is not connected to the wireless data connection.

10. The method of claim 1, wherein the second application is a background application that is active whenever the device is on, and wherein the second application monitors a plurality of files in a directory on the computer memory of the mobile device.

11. The method of claim 1, further comprising:
detecting at least a second change to the file of the plurality of files on the mobile device using the second application; and
before transmitting, via the wireless data connection, the message with the information regarding the change, queuing at least a second message with information regarding the second change to the file.

12. A non-transitory computer readable medium storing a program for updating files on a mobile device, said program comprising:
a detection module configured to detect a change in at least a file of a plurality of files on the mobile device;
a message creation module configured to queue a message with information regarding the change;
a wireless detection module configured to detect a wireless data connection;
a transmission module configured to transmit, via the wireless data connection, the message with the information regarding the change when the wireless data connection is detected.

13. The computer readable medium of claim 12, further comprising:
a reception module configured to receive, via the wireless data connection, a message with information regarding a change at a database that is in a different location than the mobile device;
a file update module configured to update at least one of the plurality of files on the mobile device based on the information regarding the change at the database that is in the different location.

14. The computer readable medium of claim 12, wherein the mobile device is a cellular telephone.

15. The computer readable medium of claim 12, wherein the mobile device is a device connected to a wireless local area network.

16. The computer readable medium of claim 12, wherein the message with information regarding the change is an XML file.

17. The computer readable medium of claim 12, wherein the queuing occurs when the device is not connected to the wireless data connection.

18. The computer readable medium of claim 12, wherein:
the detection module is configured to detect at least a second change to the file on the mobile device using the second application, and wherein
the message creation module is configured to queue a message with information regarding the second change before the transmission module transmits, via the wireless data connection, the message with the information regarding the change, and wherein
the transmission module is configured to transmit, via the wireless data connection, the message with the information regarding the change and the message with the information regarding the second change.

19. The computer readable medium of claim 12, wherein the wireless data connection is a cellular telephone connection.

20. The computer readable medium of claim 12, wherein the wireless data connection is a wireless internet connection.

21. The computer readable medium of claim 12, wherein the wireless data connection is a bluetooth data connection.

22. A mobile device comprising:
a computer memory storing a plurality of files;
an application that causes a change in at least one of the plurality of files;
a change detection module configured to detect the change in the at least one of the plurality files;
a message creation module configured to create and queue a message with information regarding the change;
a network detection module configured to detect a network connection; and
a transmitting module configured to transmit the message after the network connection is detected.

23. The mobile device of claim 22, wherein the transmitting module is configured to transmit using a wireless internet connection.

24. The mobile device of claim 22, wherein the transmitting module is configured to transmit using a cellular data connection.

25. The mobile device of claim 22, wherein the message includes information in an XML format.

26. The mobile device of claim 22, wherein the change detection module, the message creation module, the network detection module, and the transmitting module are part of a background application of the mobile device that executes separately from the application that causes a change in the at least one of the plurality of files.

27. The mobile device of claim 22, further comprising:
a reception module that receives a transmission of a message containing changes to a file in a database that is in a different location than the mobile device;
a file update module that updates at least one file of the computer memory based on the message containing changes in the database.

28. A system for synchronizing data, comprising:
a server comprising:
a server database; and
a receiving module configured to receive a cloud message that includes information related to a change in a cloud file structure;
a cloud database comprising:
the cloud file structure;
a cloud file change detection module configured to detect the change in the cloud file structure;
a cloud transmitting module configured to transmit the cloud message that includes information related to the change in the cloud file structure; and
a cloud receiving module configured to receive a mobile notification message that includes information related to detected changes in a mobile device file structure; and
a mobile device comprising:
the mobile device file structure;
a mobile file change detection module configured to detect a change in a file in the mobile device file structure; and
a mobile transmitting module configured to transmit the mobile notification message that includes the information related to the detected changes in the file in the mobile device file structure.

29. The system of claim 28, wherein
the mobile device further comprises:
a mobile receiving module configured to receive the cloud message that includes information related to the change in the cloud file structure; and
a device update module configured to update the mobile device file structure based on the cloud message.

30. The system of claim 28, wherein
the server further comprises:
a transmitting module configured to transmit a message that includes information related to changes to the server database, and wherein
the cloud receiving module is further configured to receive the message that includes information related to changes to the server database.

31. The system of claim 28, wherein the mobile device is a cellular telephone.

32. The system of claim 28, wherein the mobile transmitting module transmits via a cellular telephone connection.

33. The system of claim 28, wherein the mobile transmitting module transmits via a wireless Internet connection.

34. The system of claim 28, wherein the server, the cloud database, and the mobile device are at different geographical locations.

35. The system of claim 28, wherein
the mobile device further comprises:
an application configured to change the file in the mobile device file structure;
a message creation module configured to queue the mobile notification message; and
a wireless detection module configured to detect a wireless data connection.

36. The system of claim 35, wherein:
the mobile transmitting module transmits the mobile notification message that is queued by the message creation module after the wireless detection module detects a wireless data connection.

37. The system of claim 36, wherein:
the mobile file change detection module runs as a background application on the mobile device.

38. The system of claim 37, wherein the message creation module is configured to queue the mobile notification message when there is no wireless data connection detected by the wireless detection module.

39. The system of claim 38, wherein, the mobile notification message and the cloud notification message include an XML file with information on changes to files.

40. The method of claim 10, wherein the directory on the computer memory has a directory structure that is the same as a directory structure of a server directory.

41. The non-transitory computer readable medium of claim 12, wherein the plurality of files on the mobile device are in a directory that has a directory structure that is the same as a directory structure of a server directory.

42. The mobile device of claim 22, wherein the plurality of files on the computer memory of the mobile device are in a directory that has a directory structure that is the same as a directory structure of a server directory.

43. The system of claim 28, wherein the server database, the cloud file structure, and the mobile device file structure include at least a portion having a directory structure that is the same.
